(19) United States
(12) Patent Application Publication
(10) Pub. No.: US 2017/0302920 A1
(43) Pub. Date: Oct. 19, 2017

(54) METHODS, ENCODERS AND DECODERS FOR CODING OF VIDEO SEQUENCING

(71) Applicant: TELEFONAKTIEBOLAGET LM ERICSSON (PUBL), Stockholm (SE)

(72) Inventors: Martin PETTERSSON, Vallentuna (SE); Usman HAKEEM, Täby (SE); Jonatan SAMUELSSON, Enskede (SE); Per WENNERSTEN, Årsta (SE)

(73) Assignee: TELEFONAKTIEBOLAGET LM ERICSSON (PUBL), Stockholm (SE)

(21) Appl. No.: 15/512,203

(22) PCT Filed: Sep. 19, 2014
(86) PCT No.: PCT/SE2014/051083

§ 371 Date: Mar. 17, 2017

(51) Int. Cl. H04N 19/105; H04N 19/157; H04N 19/147; H04N 19/172; H04N 19/109

(52) U.S. Cl. CPC H04N 19/105; H04N 19/172; H04N 19/109; H04N 19/147; H04N 19/157

(57) ABSTRACT

Methods, encoders (110) and decoders (120) for encoding frames of a video sequence into an encoded representation of the video sequence are disclosed. The encoder (110) encodes (203) frames into a first set of encoded units, while specifying at least one residual parameter in one or more of the first set of encoded units. The encoder (110) encodes (204) frames into a second set of encoded units, while refraining from specifying the at least one residual parameter. The encoder (110) encodes (203) frames into a first set of encoded units, wherein each frame has a first level of fidelity. The encoder (110) encodes (204) frames into a second set of encoded units, wherein each frame has a second level of fidelity, wherein the second level is less than the first level. The decoder (120) decodes (212, 213), while obtaining a first or a second level of fidelity for each frame. When the second level is less than the first level, the decoder (120) enhances (216) a second set of frames towards obtaining the first level of fidelity for each frame of the second set. Corresponding computer programs and carriers therefor are also disclosed.

### TECHNICAL FIELD

Embodiments herein relate to the field of video coding, such as High Efficiency Video Coding (HEVC) or the like. In particular, embodiments herein relate to a method and an encoder for encoding frames of a video sequence into an encoded representation of the video sequence as well as a method and a decoder for decoding an encoded representation of frames of a video sequence into frames of the video sequence. Corresponding computer programs and carriers therefor are also provided.

### BACKGROUND

In the field of video coding, it is often desired to compress a video sequence into a coded video sequence. The video sequence may for example have been captured by a video camera. A purpose of compressing the video sequence is to reduce a size, e.g. in bits, of the video sequence. In this manner, the coded video sequence will require smaller memory when stored and/or less bandwidth when transmitted from e.g. the video camera. A so called encoder is often used to perform compression, or encoding, of the video sequence. Hence, the video camera may comprise the encoder. The coded video sequence may be transmitted from the video camera to a display device, such as a television set (TV) or the like. In order for the TV to be able to decompress, or decode, the coded video sequence, it may comprise a so called decoder. This means that the decoder is used to decode the received coded video sequence. In other scenarios, the encoder may be comprised in a radio base station of a cellular communication system and the decoder may be comprised in a wireless device, such as a cellular phone or the like, and vice versa.

A known video coding technology is called High Efficiency Video Coding (HEVC), which is a new video coding standard, recently developed by Joint Collaborative Team-Video Coding (JCT-VC). JCT-VC is a collaborative project between Moving Pictures Expert Group (MPEG) and International Telecommunication Union's Telecommunication Standardization Sector (ITU-T).

A coded picture of an HEVC bitstream is included in an access unit, which comprises a set of Network Abstraction Layer (NAL) units. NAL units are thus a format of packages which form the bitstream. The coded picture can consist of one or more slices with a slice header, i.e. one or more Video Coding Layer (VCL) NAL units, that refers to a Picture Parameter Set (PPS), i.e. a NAL unit identified by NAL unit type PPS. A slice is a spatially distinct region of the coded picture, aka a frame, which is encoded separately from any other region in the same coded picture. The PPS contains information that is valid for one or more coded pictures. Another parameter set is referred to as a Sequence Parameter Set (SPS). The SPS contains information that is valid for an entire Coded Video Sequence (CVS) such as cropping window parameters that are applied to pictures when they are output from the decoder.

Not long after High Definition TeleVision (HDTV) has become the de facto standard for broadcasted TV over the world using 720p50160 and 1080i25/30 video formats, the market demand is moving towards even higher video qualities. Over-the-top (OTT) services like Netflix has recently started streaming video in 4K resolution (3840×2160). In the road map from Digital Video Broadcasting (DVB), broadcasting standards including 1080p1001120 and 2160p50/60 are planned for 2014/2015. In the years 2017/2018, the 2160p100/120 format is also planned to be available and beyond 2020 8K video (7680×4320) is anticipated. In parallel, there is introduced other quality improvements, such as High Dynamic Range (HDR), richer color spaces, increased pixel bit depths and color formats with higher fidelity.

### Video Frame Rate and the Human Visual System

Due to local variations of the power grids in United States of America, Europe and Asia when analog TV was introduced, two different frame rates were chosen for the different TV standard formats; 25 frames per second (fps) for Phase Alternating Line (PAL) and Séquentiel Couleur A Mémoire (SECAM) and 30 fps for National Television System Committee (NTSC). Since progressive video at 25 or 30 fps could appear a bit jerky, interlaced video was also introduced. In interlaced video the video is captured in twice the frame rate compared to progressive video, but at each moment in time only every second line is captured, altering between two so called fields. This gives the impression that the video is played out in full resolution at the captured frame rate. The downside is that interlacing introduces image artefacts for high motion video.

When digital video was introduced in the broadcasting world, it inherited the frame rates from the analog TV world, also meaning that higher digital frame rates have been a multiple of 25 or 30 fps, including 50, 60, 100 and 120 fps. A strong trend today is to move away from interlaced video in favor of only progressive video.

The human eye is not able to capture all of what we think we see. For instance, the retina has a blind spot where the optic nerve passes through the optic disc. This area which is about 6 degrees in horizontal and vertical direction and outside of our focus point has no cones or rods but is still not visually detectable in most cases. Whenever there is missing information in the received visual signal, the brain is very good at filling in the blanks. The human eye is also better in detecting changes in luminance than in color due to the higher number of rod cells compared to cone cells. Also, the cone cells used to sense color are mainly concentrated in the fovea at the center of our focus point. How the human eye in combination with the brain perceives is referred to as the human visual system (HVS).

The following text about the HVS for frame rate is recited from Wikipedia: “The human eye and its brain interface, the human visual system, can process 10 to 12 separate images per second, perceiving them individually. The threshold of human visual perception varies depending on what is being measured. When looking at a lighted display, people begin to notice a brief interruption of darkness if it is about 16 milliseconds or longer. Observers can recall one specific image in an unbroken series of different images, each of which lasts as little as 13 milliseconds. When given very short single-millisecond visual stimulus people report a duration of between 100 ms and 400 ms due to persistence of vision in the visual cortex. This may cause images perceived in this duration to appear as one stimulus, such as a 10 ms green flash of light immediately followed by a 10 ms red flash of light perceived as a single yellow flash of light. Persistence of vision may also create an illusion of continuity, allowing a sequence of still images to give the impression of motion.”

For high frame rates such as 120 fps, every frame is only visible for a short period of time, at most in 8 ms for 120 fps. When visually comparing a 60 fps video with a 120 fps video a smoother motion can be perceived for the 120 fps video. However, according to the theory of the HVS, exactly what is presented for each frame may not always be so important for the visual quality.

### HEVC Version 1 Frame Rate Scalability

The HEVC version 1 codec standardized in ITU-T and MPEG contains a mechanism for frame rate scalability. A high frame rate video bitstream can efficiently be stripped on intermediate frames that are not used as reference frames for the remaining frames, to produce a reduced frame rate video with lower bitrate. The intermediate frames may be encoded with lower quality by setting the quantization parameter to a higher value for these frames compared to the other frames.

### Bit Depths

The intensity of a color channel in a digital pixel must be quantized at some chosen fidelity. For byte-alignment reasons 8 bits have typically been used for video and images historically, representing 256 different intensity levels. The bit depth in this case is thus 8 bits.

In recent years, higher bit depths have been increasingly popular, including 10 and 12 bits per color channel. The recent HDR technology would typically use more than 8 bits to represent the dynamic intensity levels of a scene.

The range extensions of HEVC, contain profiles with bit depths up to 16 bits per color channel.

### Color Formats

The color of the pixels in digital video can be represented using a number of different color formats. The color format signaled to digital displays such as computer monitors and TV screens are typically based on an Red Green Blue (RGB) representation where each pixel is divided into a red, green and blue color component. When video needs to be compressed it is convenient to express the color information of the pixel with one luma component and two color components. This is done since the human visual system (HVS) is more sensitive to luminance than to color, meaning that luminance may be represented with higher accuracy than color. This pixel format is often referred to as YUV or YCbCr where Y stands for luma and U (Cb) and V (Cr) stands for the two color components. YUV can be derived from RGB using the following formula:

$$Y = {W}_{R} R + {W}_{G} G + {W}_{B} B$$

$$U = {U}_{Max} \frac{B - Y}{1 - {W}_{B}}$$

$$V = {V}_{Max} \frac{R - Y}{1 - {W}_{R}}$$

where
W_{R}=0.299
W_{B}=0.114
W_{G}=1−W_{R}−W_{B}=0.587
U_{Max}=0.436
V_{Max}=0.615

Fourcc.org holds a list of defined YUV and RGB formats. A commonly used pixel format for standardized video codecs, e.g. for the main profiles in HEVC, H.264 and Moving Pictures Expert Group-4 (MPEG-4), is YUV420 planar where the U and V color components are subsampled in both vertical and horizontal direction and the Y, U and V components are stored in separate chunks for each frame. Thus, for a pixel representation with bit depth 8 the number of bits per pixel is 12 where 8 bits represents the luma and 4 bits the two color components. Other increasingly popular color formats are YUV422 where the color components are subsampled only in horizontal direction and YUV444 where no subsampling of the color components is performed.

The range extensions of HEVC contain profiles for both the RGB and YUV color formats including 444 sample formats.

### Transform and Transform Coefficients

Transform based codecs, such as HEVC, H.264, VP8 and VP9 typically uses some flavor of intra (I), inter (P) and bidirectional inter (B) frames. In I-frames each block predicts from within the current frame and in P- and B-frames each block predicts from one respectively two previous and/or following frames. The prediction is often made with help from motion vectors or directional pixel extrapolation modes (intra). The difference between the prediction and the reference is referred to as a residual. To efficiently reduce the number of bits needed to signal the residuals the residuals are transformed into the frequency domain before a quantization is performed. The quantized transform coefficients are then signaled instead of the full residuals. This approach efficiently reduces the required bitrate at the same time as it preserves the most important frequencies of the video.

In HEVC, each picture is divided into blocks, called coding tree units (CTUs), of size 64×64, 32×32 or 16×16 pixels. In previous video coding standards, CTUs are typically referred to as macroblocks. CTUs may further be divided into coding units (CUs) which in turn may be divided into prediction units (PUs), ranging from 32×32 to 4×4 pixels, to perform either intra or inter prediction. To code the prediction residual, a CU is divided into a quadtree of transform units (TUs). TUs contain coefficients for spatial block transform and quantization, A TU can be 32×32, 16×16, 8×8, or 4×4 pixel block sizes.

An existing system for coding of video sequences comprises an encoder and a decoder. When a frame rate of the video sequence increases by a factor of two, e.g. going from 60 frames per second (fps) to 120 fps, using the technologies currently available, the bitrate is increased by 10-25% depending on the content and how the video sequence is encoded by the encoder. Moreover, a problem may be that the increase in frame rate puts a much higher demand on the encoder and decoder in terms of complexity. A reason for that is that high complexity means in most cases higher cost.

A known solution to avoid increased demand on bit rate is to up-sample a low frame rate video stream to a high frame rate video stream by generating intermediate frames. A problem with this known solution is that, it is not possible to know what the intermediate frames should look like. The intermediate frames are generated based on better or worse guesses of what information should be present in the intermediate frame given the frames surrounding the intermediate frame. These guesses may not always provide a video sequence that is appears correct when viewed by a human. A further problem is hence that the video sequence may appear visually incorrect.

### SUMMARY

An object may be to improve efficiency and/or reduce complexity of video coding of the above mentioned kinds while overcoming, or at least mitigating at least one of the above mentioned problems.

According to an aspect, the object is achieved by a method, performed by an encoder, for encoding frames of a video sequence into an encoded representation of the video sequence, wherein the encoded representation comprises one or more encoded units representing the frames. The encoder encodes, for a first set of frames, the first set of frames into a first set of encoded units, while specifying at least one residual parameter in one or more of the first set of encoded units, wherein the at least one residual parameter instructs the decoder of how to generate residuals. The encoder encodes, for a second set of frames, the second set of frame into a second set of encoded units, while refraining from specifying the at least one residual parameter.

According to another aspect, the object is achieved by a method, performed by an encoder, for encoding frames of a video sequence into an encoded representation of the video sequence, wherein the encoded representation comprises one or more encoded units representing the frames. The encoder encodes, for a first set of frames, the first set of frames into a first set of encoded units, wherein each frame of the first set has a first level of fidelity. The encoder encodes, for a second set of frames, the second set of frame into a second set of encoded units, wherein each frame of the second set has a second level of fidelity, wherein the second level of fidelity is less than the first level of fidelity.

According to a further aspect, the object is achieved by a method, performed by a decoder, for decoding an encoded representation of frames of a video sequence into frames of the video sequence, wherein the encoded representation comprises one or more encoded units representing the frames of the video sequence. The decoder decodes a first set of encoded units into a first set of frames, while obtaining a first level of fidelity for each frame of the first set. The decoder decodes a second set of encoded units into a second set of frames, while obtaining a second level of fidelity of each frame of the second set. When the second level of fidelity is less than the first level of fidelity, the decoder enhances the second set of frames towards obtaining the first level of fidelity for each frame of the second set.

According to yet another aspect, the object is achieved by an encoder configured to encode frames of a video sequence into an encoded representation of the video sequence, wherein the encoded representation comprises one or more encoded units representing the frames. The encoder is configured to, for a first set of frames, encode the first set of frames into a first set of encoded units, while specifying at least one residual parameter in one or more of the first set of encoded units, wherein the at least one residual parameter instructs the decoder of how to generate residuals. Moreover, the encoder is configured to, for a second set of frames, encode the second set of frame into a second set of encoded units, while refraining from specifying the at least one residual parameter.

According to a still further aspect, the object is achieved by an encoder configured to encode frames of a video sequence into an encoded representation of the video sequence, wherein the encoded representation comprises one or more encoded units representing the frames. The encoder is configured to, for a first set of frames, encode the first set of frames into a first set of encoded units, wherein each frame of the first set has a first level of fidelity. The encoder is configured to, for a second set of frames, encode the second set of frame into a second set of encoded units, wherein each frame of the second set has a second level of fidelity, wherein the second level of fidelity is less than the first level of fidelity.

According to a yet other aspect, the object is achieved by a decoder configured to decode an encoded representation of frames of a video sequence into frames of the video sequence, wherein the encoded representation comprises one or more encoded units representing the frames of the video sequence. The decoder is configured to decode a first set of encoded units into a first set of frames, while obtaining a first level of fidelity for each frame of the first set. The decoder is configured to decode a second set of encoded units into a second set of frames, while obtaining a second level of fidelity of each frame of the second set. Furthermore, the decoder is configured to, when the second level of fidelity is less than the first level of fidelity, enhance the second set of frames towards obtaining the first level of fidelity for each frame of the second set.

According to some embodiments, each frame of the second set is encoded while the encoder refrains from specifying the at least one residual parameter. In this manner, number of bits in the encoded representation is reduced. Thus, required bit rate for transmission is reduced. In addition, demands on resources, such as memory and processing capacity of the encoder, is reduced as compared when almost all frames are encoded while using the at least one residual parameter. Likewise, the demands on memory and processing capacity of the decoder are also reduced. As a result, calculations to generate the at least one residual parameter may not need to be performed for the second set of frames. Hence, significant reduction of required processing capacity is achieved for the encoder as well as the decoder.

According to some embodiments herein, each frame of the second set has the second level of fidelity. Hence, each frame of the second set is represented, before encoding into the encoded representation of the video sequence, while using a reduced amount of information, e.g. number of bits, as compared to an amount of information used for each frame of the first set. For example, resolution of each frame of the second set may be less than resolution of each frame of the first set. Further examples are given in the detailed description.

More generally, the embodiments herein may typically be applied when the video sequence is a high frame rate video sequence, e.g. above 60 frames per second. With the embodiments herein only a subset of the frames of the video sequence, e.g. every second one, is encoded using full frame information in line with conventional encoding techniques. The other frames, e.g. the other every second frames, are encoded with only a subset of the full frame information comprised in the frame.

Advantageously, as mentioned above, this reduces a required bitrate for transmission of the encoded representation and at the same time quality impact of the high frame rate video is negligible. Moreover, complexity of the encoding and decoding processes is also significantly reduced.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a schematic overview of an exemplifying system in which embodiments herein may be implemented,

FIG. 2 is a schematic, combined signaling scheme and flowchart illustrating embodiments of the methods when performed in the system according to FIG. 1,

FIG. 3 is an overview of an embodiment in the encoder,

FIG. 4 is an overview of an embodiment in the encoder and decoder,

FIGS. 5a and 5b are illustrations of another embodiment in the encoder,

FIG. 6 is an overview of a further embodiment in the encoder and decoder,

FIG. 7 is a flowchart illustrating embodiments of the method in the encoder,

FIG. 8 is a flowchart illustrating embodiments of the method in the decoder,

FIG. 9 is a flowchart illustrating further embodiments of the method in the encoder,

FIG. 10 is a flowchart illustrating further embodiments of the method in the decoder,

FIGS. 11a and 11b are flowcharts illustrating embodiments of the method in the encoder,

FIG. 12 is a block diagram illustrating embodiments of the encoder.

FIG. 13 is a flowchart illustrating embodiments of the method in the decoder, and

FIG. 14 is a block diagram illustrating embodiments of the decoder.

### DETAILED DESCRIPTION

Throughout the following description similar reference numerals have been used to denote similar features, such as actions, steps, nodes, elements, units, modules, circuits, parts, items or the like, when applicable. In the Figures, features that appear in some embodiments are indicated by dashed lines.

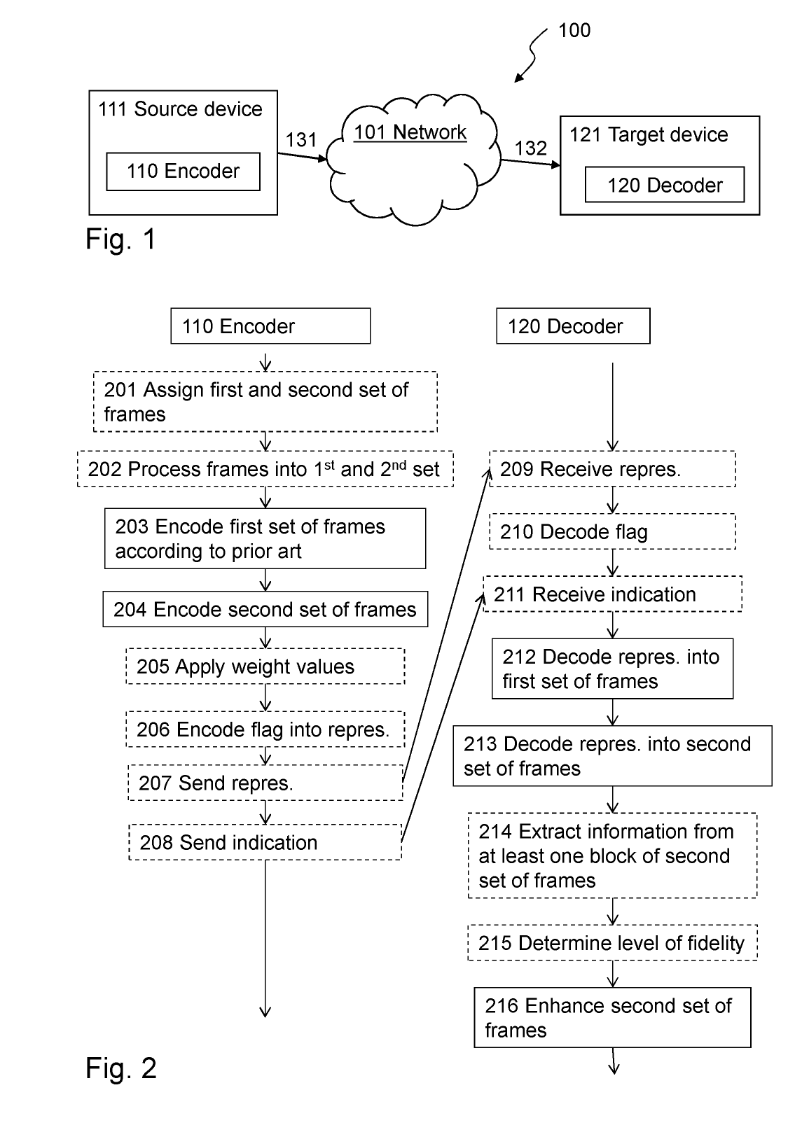

FIG. 1 depicts an exemplifying system 100 in which embodiments herein may be implemented.

The system 100 includes a network 101, such as a wired or wireless network. Exemplifying networks include cable television network, internet access networks, fiber-optic communication networks, telephone networks, cellular radio communication networks, any Third Generation Partnership Project (3GPP) network, Wi-Fi networks, etc.

In this example, the system 100 further comprises an encoder 110, comprised in a source device 111, and a decoder 120, comprised in a target device 121.

The source and/or target device 111, 121 may be embodied in the form of various platforms, such as television set-top-boxes, video players/recorders, video cameras, Blu-ray players, Digital Versatile Disc(DVD)-players, media centers, media players, user equipments and the like. As used herein, the term “user equipment” may refer to a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor may be a microphone, a loudspeaker, a camera sensor etc.

As an example, the encoder 110, and/or the source device 111, may send 131, over the network 101, a bitstream to the decoder 110, and/or the target device 121. The bitstream may be video data, e.g. in the form of one or more NAL units. The video data may thus for example represent pictures of a video sequence. In case of HEVC, the bitstream comprises a Coded Video Sequence (CVS) that is HEVC compliant.

The bitstream may thus be an encoded representation of a video sequence to be transferred from the source device 111 to the target device 121. Hence, more generally, the bitstream may include encoded units, such as the NAL units.

FIG. 2 illustrates exemplifying embodiments when implemented in the system 100 of FIG. 1.

The encoder 110 performs a method for encoding frames of a video sequence into an encoded representation of the video sequence, wherein the encoded representation comprises one or more encoded units representing the frames.

The frames may be associated to a specific frame rate that may be greater than 60 frames per second. The specific frame rate may be referred to as a high frame rate. At lower frame rates, it may happen that reduced quality/fidelity of the second of frames be noticeable for the human eye.

It is also to be understood that although a high frame rate is preferred, the embodiments herein may also be useful for lower frame rates, e.g. 25 frames per second (fps), 30 fps, 50 fps and 60 fps.

For the encoder 110, some first embodiments will first be described with reference to FIG. 2. Next, some second embodiments for the encoder 110 will be described with reference to FIG. 2 as well. Subsequently, again with reference to FIG. 2, embodiments for the decoder 120 will be described. Notably, some of the actions 201 to 216 are only performed in the first or second embodiments or in the embodiments of the decoder 120. Additionally, it shall be noted that for example action 203 and 204 come in two different versions: action 203 of the first embodiments, action 203 of the second embodiments, action 204 of the first embodiments and action 204 of the second embodiments. In this way, undue repetition of the Figures is avoided.

The embodiments herein may be applicable to HEVC, H.264/Advanced Video Coding (AVC), H.263, MPEG-4, motion Joint Photographic Experts Group (JPEG), proprietary coding technologies like VP8 and VP9 (for which it is believed that no spell-out exists) and for future video coding technologies, or video codecs. Some embodiments may also be applicable for un-coded video.

Hence, according to some first embodiments, one or more of the following actions may be performed in any suitable order.

### Action 201

In some examples, the encoder 110 may assign some of the frames to the first set of frames and all other of the frames to the second set of frames. The first set comprises every n:th frame of the frames, where n is an integer. When n is equal to two, every other frame is assigned to the second set.

In this manner, the encoder 110 may regularly spread the second set of frames in the video sequence. Thereby, it is achieved that any artefacts due to the second set of frames are less likely to be noticed by a human eye. Artefacts may disadvantageously be noted when several of frames of the second set are subsequent to each other in time order.

### Action 203

The encoder 110 encodes 203, for a first set of frames, the first set of frames into a first set of encoded units, while specifying at least one residual parameter in one or more of the first set of encoded units, wherein the at least one residual parameter instructs the decoder 120 of how to generate residuals. This action is performed according to conventional encoding techniques.

### Action 204

The encoder 110 encodes a second set of frames into a second set of encoded units, while refraining from specifying the at least one residual parameter for the second set of frames. Accordingly, the second set of encoded units are free from the at least one residual parameter. In this manner, a number of bits of the encoded representation is reduced and complexity of the encoder 110 is reduced since no residual parameter are encoded for the second set of frames.

The refraining from specifying the at least one residual parameter may be performed only for inter-coded blocks of the second set of frames. As a consequence, the at least one residual parameter is not skipped, or excluded from encoding, for intra-coded blocks. Intra-coded blocks are not dependent on blocks from other frames, possibly adjacent in time, which would make any reconstruction of the excluded at least one residual parameter difficult, if not impossible. Hence, the intra-coded blocks normally include the at least one residual parameter for high quality video.

The intra-coded blocks may thus generally be prohibited from forming part of the second set of frames. Hence, this also applies for the second embodiments below.

The encoded representation may be encoded using a color format including two or more color components, wherein the refraining from specifying the at least one residual parameter may be performed only for a subset of the color components. In more detail, only one or two of the color components, or color channels, such as the chroma channels, may be encoded without the at least one residual parameter, such as transform coefficients.

### Action 205

In some embodiments, the refraining from specifying the at least one residual parameter may be replaced by that the encoder 110 may apply a first weight value for Rate Distortion Optimization (RDO) of the encoder 110 that is higher than a second weight value for RDO of the encoder 110, wherein the first weight value relates to the at least one residual parameter and the second weight value relates to motion vectors. In this manner, the at least one residual parameter may be encoded into the encoded units less frequent than frequency of encoding motion vectors into the encode units.

As an example, this means that the RDO in the encoder 110 has a higher cost (weight) for transform coefficient bits than for motion vector bits for the second set of frames. As a result, transform coefficients are less likely to be encoded.

### Action 207

The encoder 110 may send the encoded representation, or “repres.” for short in the Figure, to the target device 121.

### Action 208

The encoder 110 may send, to a target device 121, an indication of that the at least one residual parameter is excluded from the second coded units.

The encoded representation may comprise the indication. As an example, the indication may be included in a Supplemental Enhancement Information (SEI) message in case of HEVC, H.264 and the like.

In further examples, the indication may be included in high level signaling, such as Video Usability Information (VUI), SPS or PPS.

In another embodiment, the encoder 110 signals in the encoded representation that a frame is included among the second set of frames, e.g. the frame does not use transform coefficients, or other information not contained in the second set of frames according to the embodiments herein. This enables the decoder 120, if it has limited resources, such as processing power, to know that it will in fact be able to decode all frames of the video sequence even if the decoder 120 normally would not support decoding of all frames of a video sequence with the current frame rate, e.g. a current high frame rate.

This means that the encoder 110 may send one or more of the following indications:

an indication of the resolution of frames encoded into the second encoded units;

an indication of the bit depth of frames encoded into the second encoded units;

an indication of the color format of frames encoded into the second encoded units; and similar according to the embodiments herein.

In a version of this embodiment, a certain amount or percentage of transform coefficients are allowed per sub-information frame. This information may also be signaled in the bitstream. The term “sub-information frame” may refer to any frame of the frames in the second set of frames.

The signaling could be made in an SEI message in the beginning of the sequence or for the affected frames, in the VUI, SPS or PPS or at the block level.

In the tables below are examples of possible SEI messages sent for an entire sequence and for each sub-information frame or NAL belonging to a sub-information frame.

In the example in Table 2 a seq_skip_any_transform_coeffs_flag is sent to indicate if transform skips are forced for any frames. If so a seq_skip_transform_coeffs_pattern is sent to indicate the repeated sub-information frame pattern in the video sequence. For instance, having a full-information frame every third frame with the rest of the frames being sub-information frames is indicated with the bitpattern 011. The term “full-information frame” may refer to any frame of the frames in the first set of frames. A pic_skip_all_transform_coeffs_flag is also signaled for indicating whether the sub-information frames skips all transform coefficients or if some percentage is allowed indicated by pic_allowed_perc_transform_coeffs.

TABLE 2
Example of SEI message sent for a sequence to indicate if all
transform coefficients for the sub-information frames have been
skipped or if they are allowed for a certain percentage of the blocks.

| seq_transform_skip_info( payloadSize ) { | Descriptor |
|---|---|
| seq_skip_any_transform_coeffs_flag | u(1) |
| if( !seq_skip_any_transform_coeffs_flag ) | |
| seq_skip_transform_coeffs_pattern | ue(v) |
| pic_skip_all_transform_coeffs_flag | u(1) |
| if( !pic_skip_all_transform_coeffs_flag ) | |
| pic_allowed_perc_transform_coeffs | ue(v) |

In the example in Table 3 a pic_skip_all_transform_coeffs_flag is signaled to indicate if the current picture skips all transform coefficients. If not, the allowed percentage of transform coefficients is indicated by pic_allowed_perc_transform_coeffs.

TABLE 3
Example of SEI message sent for a frame to indicate if
all transform coefficients have been skipped or if
they are allowed for a certain percentage of the blocks.

| pic_transform_skip_info( payloadSize ) { | Descriptor |
|---|---|
| pic_skip_all_transform_coeffs_flag | u(1) |
| if( !pic_skip_transform_coeffs_flag ) | |
| pic_allowed_perc_transform_coeffs | ue(v) |

Hence, according to some second embodiments, the encoder 110 performs a method for encoding frames of a video sequence into an encoded representation of the video sequence. The encoded representation comprises one or more encoded units representing the frames.

Again, the frames may be associated to a specific frame rate that may be greater than 60 frames per second. The specific frame rate may be referred to as a high frame rate. At lower frame rates, it may happen that reduced quality/fidelity of the second of frames will be noticeable for the human eye.

As mentioned, it is also to be understood that although a high frame rate is preferred, the embodiments herein may also be useful for lower frame rates, e.g. 25 frames per second (fps), 30 fps, 50 fps and 60 fps.

One or more of the following actions may be performed in any suitable order, according to the second embodiments.

### Action 201

This action is the same as action 201 of the first embodiments. The encoder 110 may assign some of the frames to the first set of frames and some other of the frames to the second set of frames, wherein the first set comprises every n:th frame of the frames, wherein n may be an integer. The n may be equal to two.

### Action 202

Before encoding of frames in action 203 and 204, the encoder 110 may process the frames into the first set of frames or the second set of frames. For some embodiments, no action is required for processing of frames into the first set of frames.

The encoded representation may be encoded using a color format including two or more color components, wherein the first level of fidelity may be obtained by that the processing may be performed while specifying information for all color components of the color format for the first set of frames, wherein the second level of fidelity may be obtained by that the processing 202 may be performed while refraining from specifying information for at least one of the color components of the color format for the second set of frames.

The color components of the color format may consist of two chroma components, and wherein the color format comprises a luma component.

These embodiments are further described with reference to FIG. 4 below.

At least one block of at least one frame of the second set may be encoded with the first level of fidelity.

More generally, at least one block of at least one frame of the second set may be treated as being comprised in a frame of the first set. For example, this means that a block of a frame in the second set may still include the at least one residual parameter, high resolution, high bit depth, high color format as in the frames of the first set.

### Action 203

The encoder 110 encodes, for a first set of frames, the first set of frames into a first set of encoded units. Each frame of the first set has a first level of fidelity.

### Action 204

The encoder 110 encodes, for a second set of frames, the second set of frame into a second set of encoded units, wherein each frame of the second set has a second level of fidelity. The second level of fidelity is less than, i.e. lower than, the first level of fidelity.

### Action 205

The encoder 110 may encode a flag into the encoded representation, wherein the flag indicates whether said at least one block is encoded with the first level of fidelity.

The flag may be signaled in the encoded representation for each encoded block e.g. at CTU, CU or TU level in HEVC, in an SEI message or within the picture parameter set PPS.

The first level of fidelity may be obtained by that the processing 202 may be performed while utilizing a first frame resolution for the first set of frames, wherein the second level of fidelity may be obtained by that the encoding 203 may be performed while utilizing a second frame resolution for the second set of frames, wherein the second frame resolution is less than, i.e. lower than, the first frame resolution. This embodiment is further described with reference to FIG. 6.

The first level of fidelity may be obtained by that the processing 202 may be performed while utilizing a first bit depth of color information for the first set of frames, wherein the second level of fidelity may be obtained by that the processing 202 may be performed while utilizing a second bit depth of color information for the second set of frames, wherein the second bit depth of color information may be less than, i.e. lower than, the first bit depth of color information. This means that the second set of frames are processed, in a lossy manner, to a bit depth that is lower that a bit depth of the first set of frames.

For instance, if the video sequence uses 10 bits to represent each color channel, the first set of frames would be encoded using 10 bits per color channel. The pixels in the second set of frames could be down-converted to 8 bits per channel before encoding. At the decoding side, as in action 216, the second set of frames would if needed be up-converted to 10 bits per color channel.

The first level of fidelity may be obtained by that the processing 202 may be performed while utilizing a first color format for the first set of frames, wherein the second level of fidelity may be obtained by that the processing 203 may be performed while utilizing a second color format for the second set of frames, wherein a number of bits used for the second color format may be less than, i.e. lower than, a number of bits used for the first color format.

In yet another embodiment, the second set of frames is encoded using a different color format than that of the first set of frames. The color format of the second set of frames may be a format with lower bit representation than a format of the first set of frames.

For instance, the pixels in the first set of frames using a bit depth of 8 could be represented in the YUV444 color format where each pixel would have a bit count of 24 (8+8+8). The second set of frames could then before encoding be converted into the YUV420 format where each pixel would have a bit count of 12 (8+2+2) after color subsampling. After decoding as in action 216, the second set of frames could if needed be converted back to the YUV444 color format.

Now turning to the actions performed by the decoder 120. The decoder 120 needs not to make any special action when the encoder 110 performs the actions of the first embodiments. However, when the encoder 110 performs the actions of the second embodiments, the decoder 120 may perform a method for decoding an encoded representation of frames of a video sequence into frames of the video sequence. The encoded representation comprises one or more encoded units representing the frames of the video sequence.

One or more of the following actions may be performed in any suitable order by the decoder according to the second embodiments.

### Action 209

The decoder 120 may receive the encode representation from the encoder 110 and/or the source device 111.

### Action 210

The decoder 120 may decode the flag from the encoded representation. The flag is further described above in relation to action 206.

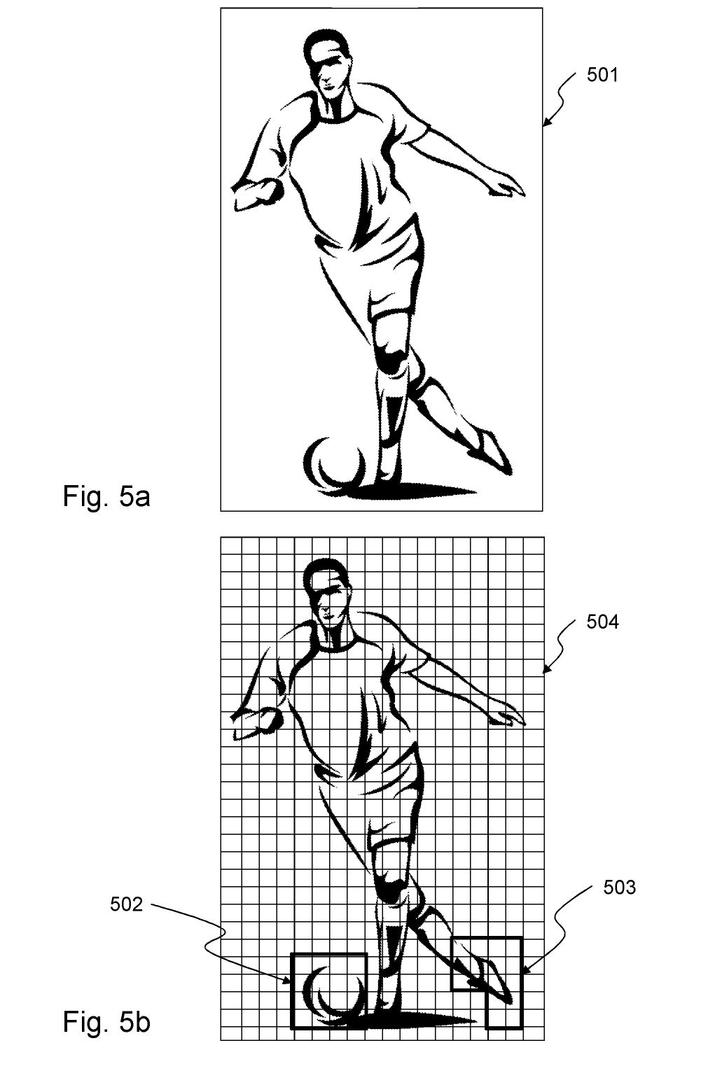

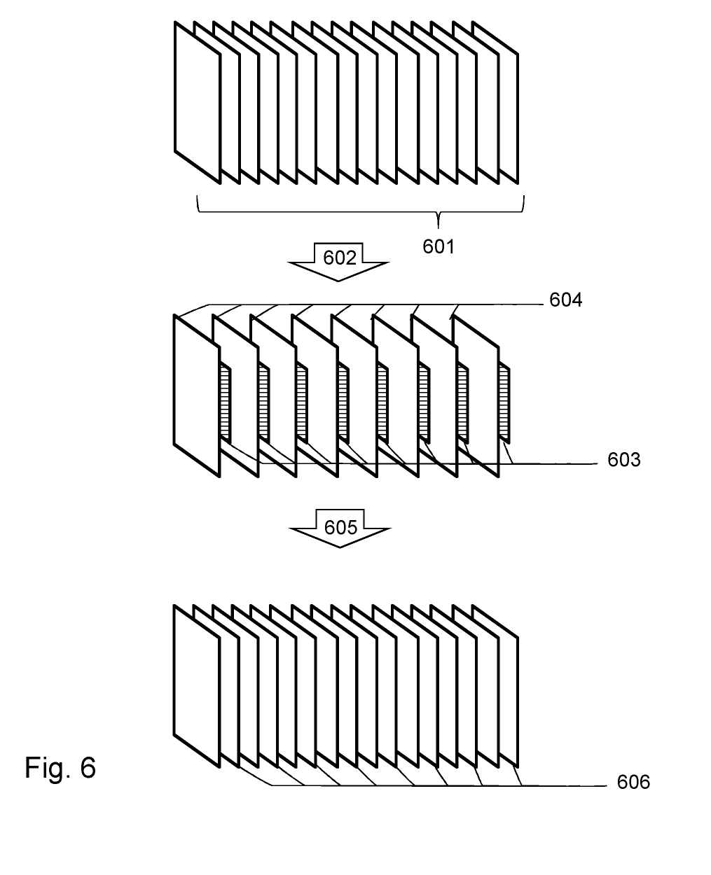

Furthermore, the second set of frames may comprise at least one block. Then, the decoder 120 may decode the flag from the encoded representation, wherein the flag indicates whether said at least one block may be encoded with the first level of fidelity or not. This is explained in more detail with reference to FIGS. 5a and 5b.

### Action 211

The decoder 120 may receive the indication from the encoder 110. The indication is described above in connection with action 208.

### Action 212

The decoder 120 decodes the first set of encoded units into a first set of frames, while obtaining a first level of fidelity for each frame of the first set. Expressed differently, the decoder 120 decodes the first set of encoded units to obtain the first set of frames.

### Action 213

The decoder 120 decodes a second set of encoded units into a second set of frames, while obtaining a second level of fidelity of each frame of the second set. Expressed differently, the decoder 120 decodes the second set of encoded units to obtain the second set of frames.

### Action 214

The second set of frames may comprise at least one block.

The decoder 120 may extract information from said at least one block, said extracted information being one of motion information, color information or at least one residual parameter.

### Action 215

The decoder 120 may determine based on the extracted information whether said at least one block may be encoded with the first level of fidelity or not.

### Action 216

When the second level of fidelity is less than, i.e. lower than, the first level of fidelity, the decoder 120 enhances the second set of frames towards obtaining the first level of fidelity for each frame of the second set.

The encoded representation may be encoded using a color format including two or more color components, wherein the first and second levels of fidelity relates to availability of at least one color component, wherein the enhancing 216 comprises deriving at least one further color component for each frame of the second set based on said at least one color component that may be available from frames preceding and/or following said each frame. Expressed differently, this means that color, or color component, may be copied from at least one of the previous frames and the following frames. In this manner, for the second set of frames, information to be used as said at least one further color component is reconstructed by copying the color information from a reference frame, e.g. the previous frame.

In further examples, motion vectors may be used for copying the color information from a reference frame. The motion vectors may be the same as used for the luma component or may be derived using motion estimation from the luma component of surrounding frames.

For this embodiment a subjective viewing was performed for a few 120 fps high motion sequences to evaluate the effect of copying color information for sub-information frames from previous frames. Results of this subjective viewing indicate that color scattering or false color artefacts were not visible in real time.

As a further example, the derivation of the at least one color component may be based on frame interpolation.

As yet another example, the derivation of the at least one color component may be based on frame copying, i.e. the derived at least one color component is a copy of a color component for a preceding or following frame, or block.

The derived at least one further color component represents chroma information of the color format, wherein the color format may be a YUV format. Fourcc.org, which defines four letter codes for different formats, refers to the group of YUV formats as simply YUV formats. See http://fourcc.org/yuv.php

The first and second levels of fidelity may relate to frame resolution, wherein the enhancing 216 may comprise up-scaling the second level of frame resolution to the first level of frame resolution. This embodiment is further described with reference to FIG. 6.

The first and second levels of fidelity may relate to bit depth of color information, wherein the enhancing 216 may comprise up-sampling the second level of bit depth to the first level of bit depth.

The first level of fidelity may relate to a first color format and the second level of fidelity may relate to a second color format, wherein the enhancing 216 may comprise converting the second color format to the first color format.

In some embodiments, action 216 is not performed. In these embodiments, the second level of fidelity remains for the second set of frames. Accordingly, the second set of frames may in one embodiment be left as monochrome frames.

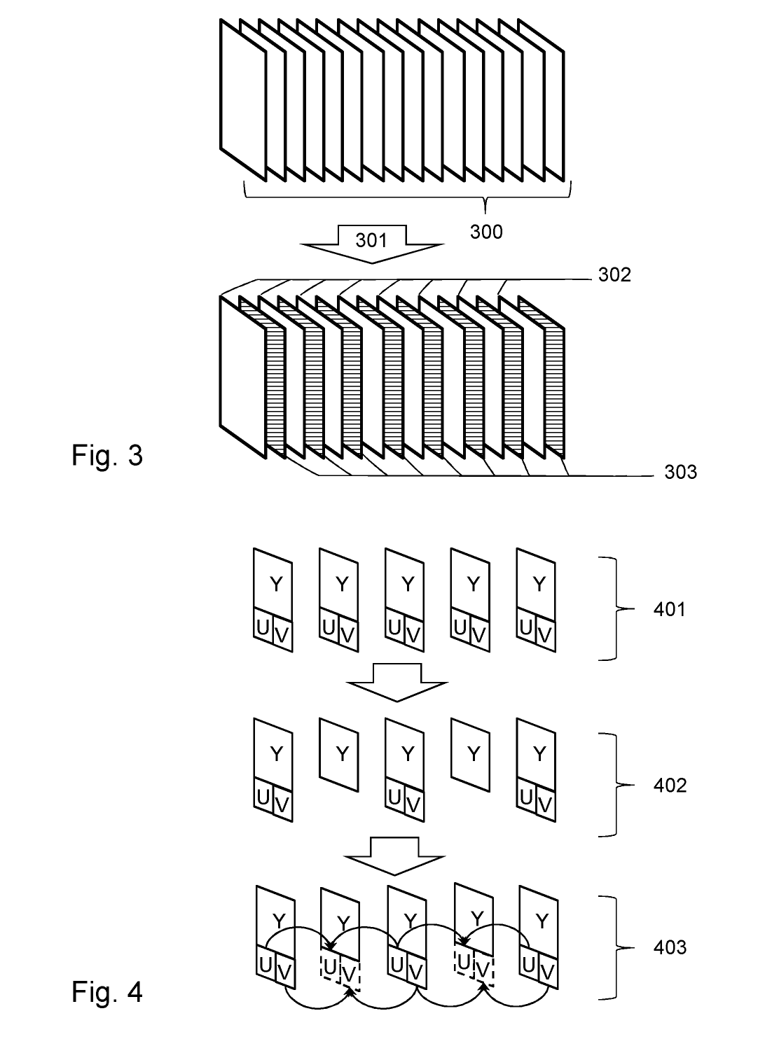

FIG. 3 illustrates schematically the embodiments herein. The upper portion of the Figure illustrates that a sequence of frames 300 includes full information, i.e. the frame quality is not reduced. In relation to FIG. 2, the sequence of frames corresponds to the video sequence before the first and second set of frames are obtained. The sequence of frames 300 may be processed 301 in order to form the first set of frames 302 and the second set of frames 303. The first set of frames 302 may be referred to as full information frames, shown as plain frames, and the second set of frames 303 may be referred to as sub-information frames, shown as striped frames. The second set of frames thus includes a sub-set of the full information.

Note that other distributions of the sub-information frames than every second frame may be used, for instance having full information frames every third or fourth frame and the remaining frames as sub-information frames.

Sub-information frames would typically be either P- or B-frames and in case of hierarchical B-frame coding structure the B-frames would typically belong to a high temporal layer. Hierarchical B-frame coding structures are known in the art and need not be explained or described here. Pictures in a higher temporal layer may reference pictures in a lower temporal level, but may not be referenced by pictures in a lower temporal level. Full-information frames could be of any picture type (I, P, or B) and would typically belong to a lower temporal layer than the sub-information frames as it is an advantage to have high quality pictures as reference pictures.

With reference to FIG. 4, a further embodiment is illustrated. Continuing from action 202 above, the second level of fidelity may be obtained by that the processing 202 may be performed while refraining from specifying information for at least one of the color components of the color format for the second set of frames. This may mean that the second set of frames is a set of monochrome frames.

In FIG. 4, the color format is represented by three color components Y, U and V. Y is luma information, U and V are chroma information. The color format blocks 401 may relate to full information frames, or the first set of frames.

In another embodiment, the second set of frames are encoded using only luma information as monochrome frames without adding color information, i.e. in the form of the chroma information, to the encoded representation of these frames. This may mean that the processing 202 removes chroma information U, V as shown at every other color format block 402.

On the decoder side the bitstream is decoded in a conventional manner. For the sub-information frames that was encoded as monochrome images, the color information is interpolated, see arrows in FIG. 4, from preceding and following frames that have been encoded with color information. After interpolation, all color format blocks 403 include both chroma information U,V and luma information Y.

Referring to the embodiments relating to one or more residual parameter, chroma transform coefficients, as an example of the one or more residual parameter, are not signaled, i.e. encoded into the encoded representation, for the second set of frames. Although bitrate savings are minimal for this case, this embodiment reduces encoder complexity by decreasing number of rate distortion mode decisions. Moreover, the embodiment reduces the decoder complexity by decreasing the number of inverse transforms that needs to be carried out.

The video is encoded with no color information in the sub-information frames. After decoding, the color channels are reconstructed by interpolating the color information from the preceding and following frames.

In case of RGB input, only one of the color channels (e.g. G) may be encoded for the sub-information frames.

Even though it is presented here that only one color channel (in the above examples Y and G) is encoded in the sub-information frames it should be understood by a person skilled in the art that it would also be possible to encode two color channels (e.g. YU or RG) and derive only the third color channel from the preceding and following frames.

FIGS. 5a and 5b illustrate embodiments herein. FIG. 5a represents a full color frame 501, or image, of a soccer player.

In FIG. 5b, only the blocks 502, 503 are in full color. The remainder of the frame 504 is in grey scale or black and white. Clearly, blocks 502 and 503 represents portions of the image where motion is expected.

Hence, in some embodiments areas, such as the blocks 502, 503, may be detected and full information, e.g. the color format is kept intact, may be available for these blocks even in cases where the entirety of the frame 504 is included in the second set of frames.

As an example, for each area, e.g. blocks 502, 503, the encoder 110 determines whether the area should be encoded using full information of the frame or only a subset of the full information in the frame for the current area. Sometimes, the area may be predetermined e.g. by a photographer operating a recording device, such as the source device, used to capture the video sequence.

The signaling of what areas in a sub-information frame should be decoded and processed as sub-information frames and what areas should be decoded and processed as full-information frames could be performed either implicitly or explicitly. Implicitly by detecting on the decoding side what characteristics the area has or explicitly by signaling which areas only uses sub-information, e.g. by sending a flag for each block such as in action 206.

For instance, in a sub-information frame with exceptional motion, the encoder 110 decides to encode certain blocks with full information and the remainder of the frame as a monochrome image. A flag is set for each block, determining whether the block encodes the color components or not.

Areas with high motion could for instance be detected by checking for long motion vectors. In case the sub-information reduction is only done for chroma, a check could also be made if the area contains objects with notable color.

In an analogues example using the solution in the preferred embodiment, the remainder of the blocks in the sub-information frame is encoded without transform coefficients.

FIG. 6 further describes embodiments of action 202 and 216. Initially, at the upper portion of the figure, a video sequence, including frames 601, is illustrated. The second set of frames 603 may be processed 602, as an example of action 202, into a lower resolution than the first set of frames 604. At the decoder 120 side, the second set of frames are up-scaled 605, as an example of action 216, to the same resolution as the first set of frames. Thus, after decoding, the second set of frames are up-scaled to the size of the first set of frames.

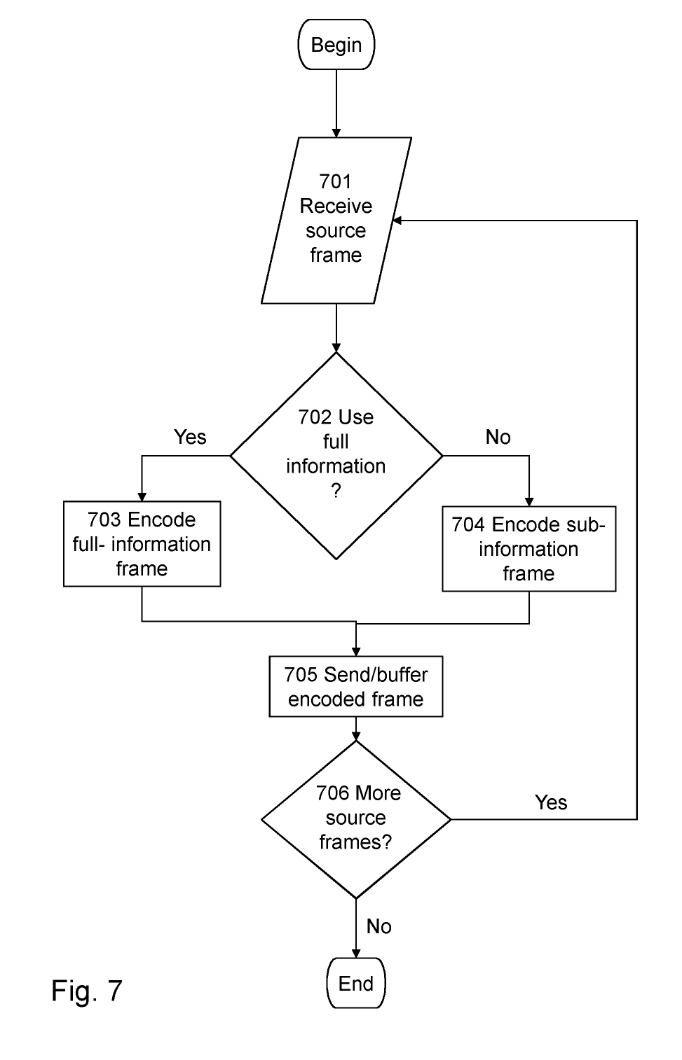

FIG. 7 is another flowchart illustrating an exemplifying method performed by the encoder 110. The following actions may be performed.

### Action 701

The encoder 110 receives one or more source frames, such as frames of a video sequence.

### Action 702

The encoder 110 determines whether or not full information about the frame should be encoded.

### Action 703

If the preceding action leads to that the full information should be encoded, the encoder 110 encodes the one or more source frames using the full information.

### Action 704

If action 702 leads to that the full information should not be encoded, the encoder 110 encodes the one or more source frames using sub-information, i.e. a sub-set of the full information.

### Action 705

The encoder 110 sends, or buffers, the encoded frame. E.g. the frame may now be represented by one or more encoded units, such as NAL units.

### Action 706

The encoder 110 checks if there are more source frames. If so, the encoder 110 returns to action 701. Otherwise, the encoder 110 goes to standby.

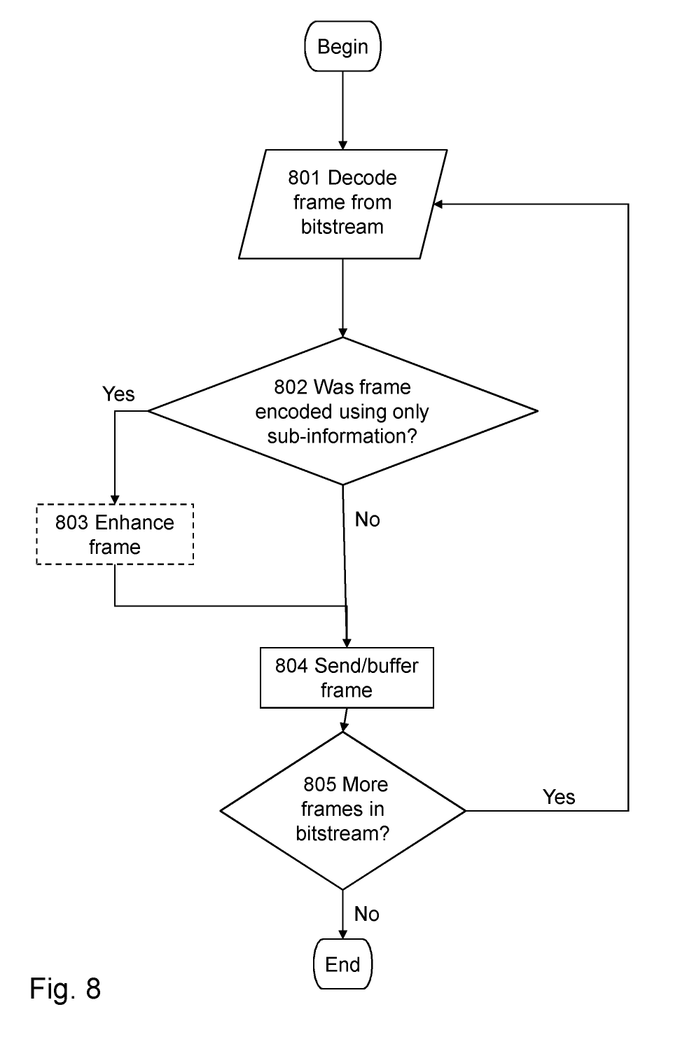

FIG. 8 is a still other flowchart illustrating an exemplifying method performed by the decoder 120. The following actions may be performed.

### Action 801

The decoder 120 decodes one or more encoded units, such as NAL units, of an encoded representation of a video sequence to obtain a frame. The encoded representation may be a bitstream.

### Action 802

The decoder 120 determines whether or not the frame was encoded using full information or a sub-set of the full information about the frame.

### Action 803

If the preceding action leads to the conclusion that the full information was encoded, the decoder 120 proceeds to action 804.

If action 802 leads to that the conclusion that the sub-set of the full information was used when encoding the frame, the decoder 120 may enhance the frame. The enhancement of the frame may be performed in various manners as described herein. See for example action 216.

### Action 804

The decoder 120 sends, e.g. to a display, a target device or a storage device, or buffers, the decoded frame. E.g. the frame may now be represented in a decoded format.

### Action 805

The decoder 120 checks if there are more frames in the bitstream. If so, the decoder 120 returns to action 801. Otherwise, the decoder 120 goes to standby.

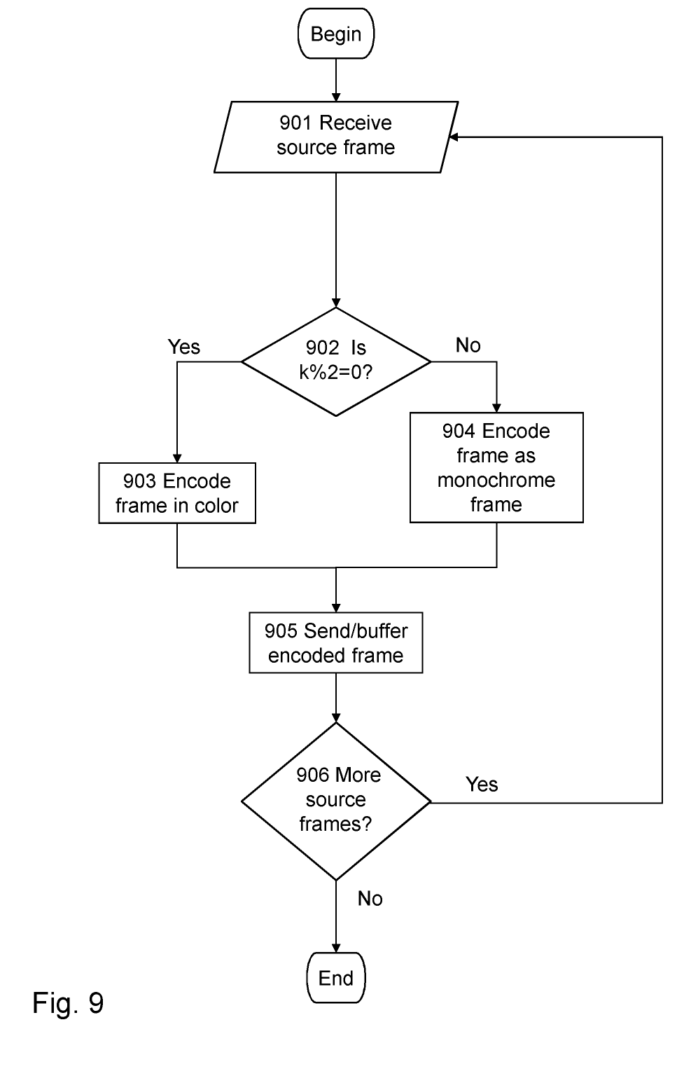

FIG. 9 is yet another flowchart illustrating an exemplifying method performed by the encoder 110.

The following actions may be performed.

### Action 901

The encoder 110 receives one or more source frames, such as frames of a video sequence.

### Action 902

The encoder 110 determines whether or not full information about the frame should be encoded by counting the number of source frames. If the number of source frames is even, the encoder 110 proceeds to action 903 and otherwise if the number of source frames is odd, the encoder 110 proceeds to action 904

### Action 903

The encoder 110 encodes the one or more source frames using the full information, e.g. encodes the frame with color.

### Action 904

The encoder 110 encodes the one or more source frames using sub-information, i.e. a sub-set of the full information. As an example, the source frame is encoded as a monochrome frame

### Action 905

The encoder 110 sends, or buffers, the encoded frame. E.g. the frame may now be represented by one or more encoded units, such as NAL units.

### Action 906

The encoder 110 checks if there are more source frames. If so, the encoder 110 returns to action 901. Otherwise, the encoder 110 goes to standby.

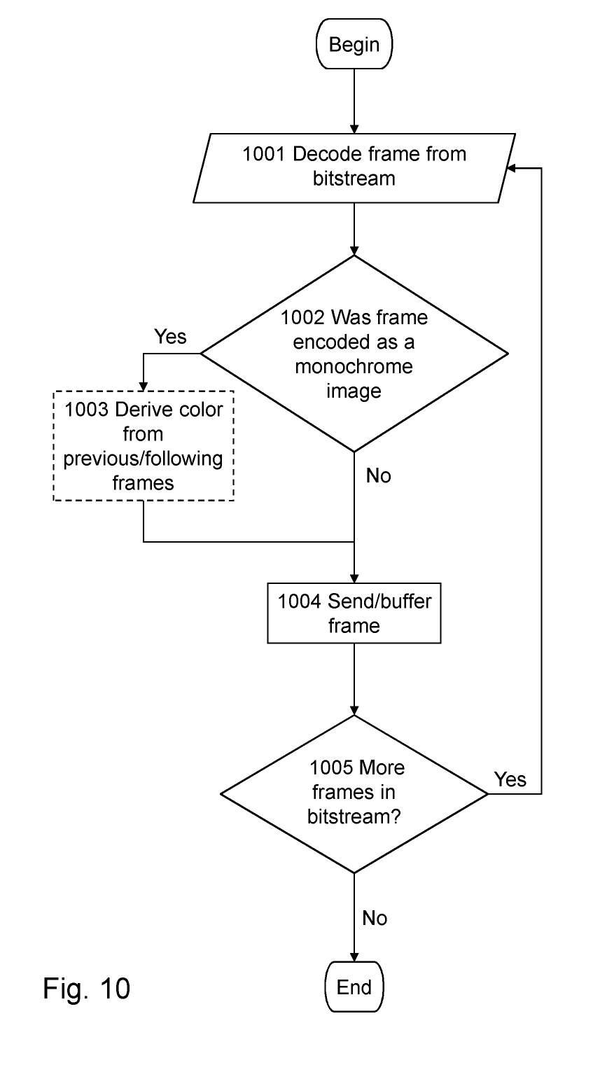

FIG. 10 is a yet further flowchart illustrating an exemplifying method performed by the decoder 120.

The following actions may be performed.

### Action 1001

The decoder 120 decodes one or more encoded units, such as NAL units, of an encoded representation of a video sequence to obtain a frame. The encoded representation may be a bitstream.

### Action 1002

The decoder 120 determines whether or not the frame was encoded using full information or a sub-set of the full information about the frame. In this example, the decoder 120 checks if the frame is a monochrome frame.

### Action 1003

If it is a monochrome frame, then the decoder 120 derives color from previous and/or following frames.

### Action 1004

The decoder 120 sends, e.g. to a display, a target device or a storage device, or buffers, the decoded frame. E.g. the frame may now be represented in a decoded format.

### Action 1005

The decoder 120 checks if there are more frames in the bitstream. If so, the decoder 120 returns to action 1001. Otherwise, the decoder 120 goes to standby.

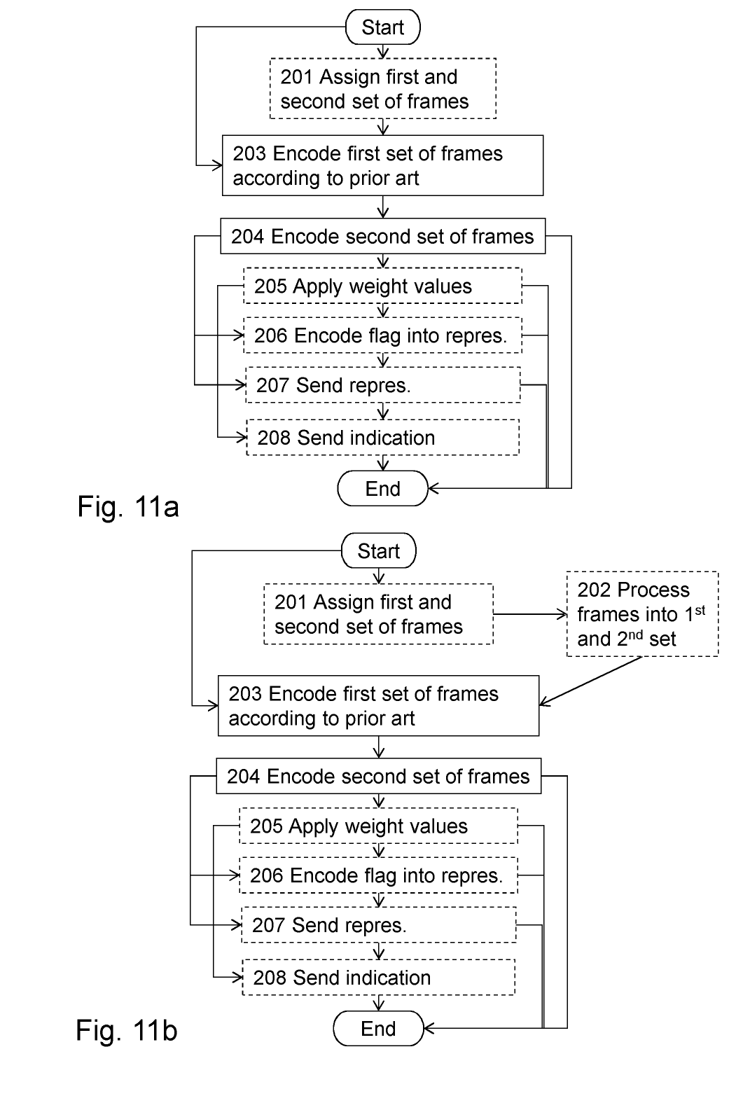

Now turning to FIG. 11a and FIG. 11b, in which the first and second embodiments of method performed by the encoder 110 are illustrated. In order to reduce repetition of Figures, the same or similar actions in the first and second embodiments are only illustrated once. A difference, notable in the Figure, relates to performing, or non-performing of action 202. Further differences will be evident from the following text.

In FIG. 11a, an exemplifying, schematic flowchart of the method in the encoder 110 according to the first embodiments is shown. The same reference numerals as used in connection with FIG. 2 have been applied to denote the same or similar actions. The encoder 110 performs a method for encoding frames of a video sequence into an encoded representation of the video sequence.

As mentioned, the encoded representation comprises one or more encoded units representing the frames. The frames may be associated to a specific frame rate that may be greater than 60 frames per second.

One or more of the following actions may be performed in any suitable order.

### Action 201

The encoder 110 may assign 201 some of the frames to the first set of frames and all other of the frames to the second set of frames, wherein the first set comprises every n:th frame of the frames, wherein n is an integer. The n may be equal to two.

### Action 203

The encoder 110 encodes, for a first set of frames, the first set of frames into a first set of encoded units, while specifying at least one residual parameter in one or more of the first set of encoded units, wherein the at least one residual parameter instructs the decoder 120 of how to generate residuals.

### Action 204

The encoder 110 encodes, for a second set of frames, the second set of frame into a second set of encoded units, while refraining from specifying the at least one residual parameter. The refraining from specifying the at least one residual parameters may be performed only for inter-coded blocks of the second set of frames.

The encoded representation may be encoded using a color format including two or more color components, wherein the refraining from specifying the at least one residual parameter may be performed only for a subset of the color components.

### Action 205

The refraining from specifying the at least one residual parameter may be replaced by applying a first weight value for rate distortion optimization “RDO” of the encoder 110 that is higher than a second weight value for RDO of the encoder 110. The first weight value may relate to the at least one residual parameter and the second weight value may relate to motion vectors, whereby the at least one residual parameter may be encoded into the encoded units less frequent than frequency of encoding motion vectors into the encode units.

### Action 206

The encoder 110 may encode a flag into the encoded representation, wherein the flag indicates whether said at least one block is encoded with the first level of fidelity.

### Action 207

The encoder 110 may send the encoded representation, or “repres.” for short in the Figure, to the target device 121.

### Action 208

The encoder 110 may send, to a target device 121, an indication of that the at least one residual parameter is excluded from the second coded units. The encoded representation may comprise the indication.

In FIG. 11b, an exemplifying, schematic flowchart of the method in the encoder 110 according to the second embodiments is shown. The same reference numerals as used in connection with FIG. 2 have been applied to denote the same or similar actions. The encoder 110 performs a method for encoding frames of a video sequence into an encoded representation of the video sequence.

As mentioned, the encoded representation comprises one or more encoded units representing the frames. The frames may be associated to a specific frame rate that may be greater than 60 frames per second.

One or more of the following actions may be performed in any suitable order.

### Action 201

The encoder 110 may assign some of the frames to the first set of frames and some other of the frames to the second set of frames, wherein the first set comprises every n:th frame of the frames, wherein n may be an integer. The n may be equal to two.

### Action 202

Before encoding of frames in action 203 or 204, the encoder 110 may process the frames into the first set of frames or the second set of frames.

The encoded representation may be encoded using a color format including two or more color components, wherein the first level of fidelity may be obtained by that the processing 202 may be performed while specifying information for all color components of the color format for the first set of frames, wherein the second level of fidelity may be obtained by that the processing 202 may be performed while refraining from specifying information for at least one of the color components of the color format for the second set of frames.

The color components of the color format may consist of two chroma components, and wherein the color format comprises a luma component.

The first level of fidelity may be obtained by that the processing 202 may be performed while utilizing a first frame resolution for the first set of frames, wherein the second level of fidelity may be obtained by that the encoding 203 may be performed while utilizing a second frame resolution for the second set of frames, wherein the second frame resolution is less than the first frame resolution.

The first level of fidelity may be obtained by that the processing 202 may be performed while utilizing a first bit depth of color information for the first set of frames, wherein the second level of fidelity may be obtained by that the processing 202 may be performed while utilizing a second bit depth of color information for the second set of frames, wherein the second bit depth of color information may be less than the first bit depth of color information.

The first level of fidelity may be obtained by that the processing 202 may be performed while utilizing a first color format for the first set of frames, wherein the second level of fidelity may be obtained by that the processing 203 may be performed while utilizing a second color format for the second set of frames, wherein a number of bits used for the second color format may be less than a number of bits used for the first color format.

### Action 203

The encoder 110 encodes, for a first set of frames, the first set of frames into a first set of encoded units, wherein each frame of the first set has a first level of fidelity.

### Action 204

The encoder 110 encodes, for a second set of frames, the second set of frame into a second set of encoded units, wherein each frame of the second set has a second level of fidelity, wherein the second level of fidelity is less than the first level of fidelity.

At least one block of at least one frame of the second set may be encoded with the first level of fidelity.

### Action 206

The encoder 110 may encode a flag into the encoded representation, wherein the flag indicates whether said at least one block is encoded with the first level of fidelity.

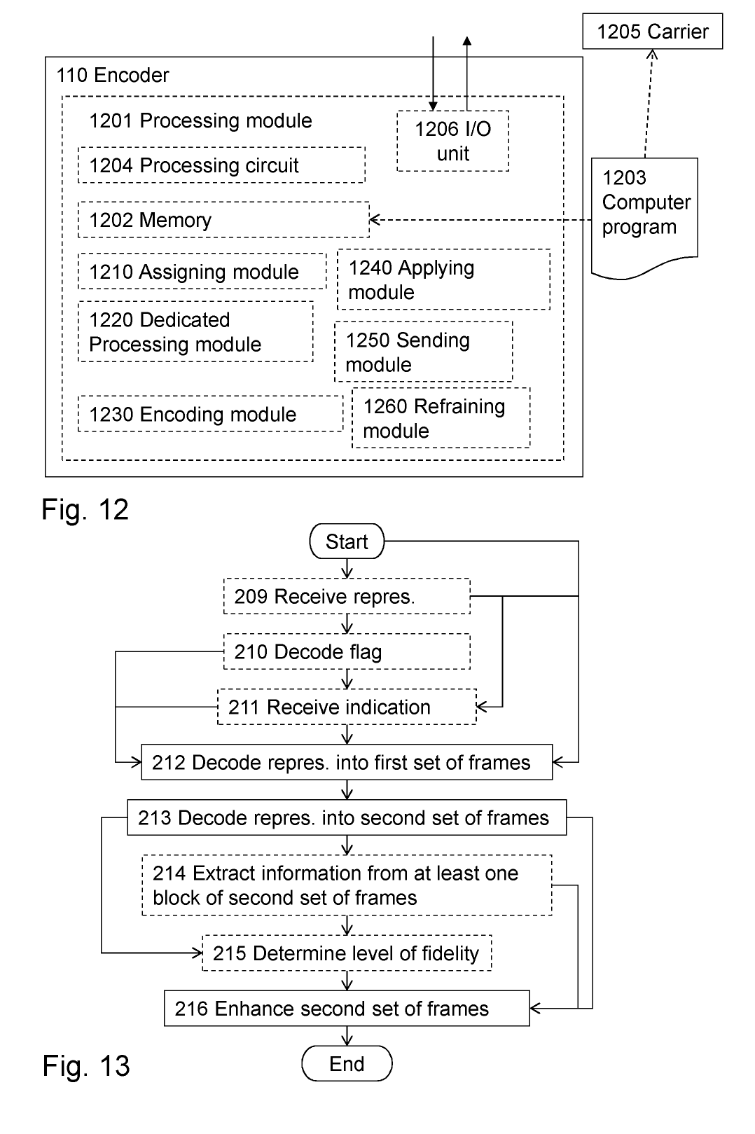

With reference to FIG. 12, a schematic block diagram of the encoder 110 is shown. The encoder 110 is configured to encode frames of a video sequence into an encoded representation of the video sequence.

As mentioned, the encoded representation comprises one or more encoded units representing the frames. The frames may be associated to a specific frame rate that may be greater than 60 frames per second.

The encoder 110 may comprise a processing module 1201, such as a means, one or more hardware modules and/or one or more software modules for performing the methods described herein.

The encoder 110 may further comprise a memory 1202. The memory may comprise, such as contain or store, a computer program 1203.

According to some embodiments herein, the processing module 1201 comprises, e.g. ‘is embodied in the form of’ or ‘realized by’, a processing circuit 1204 as an exemplifying hardware module. In these embodiments, the memory 1202 may comprise the computer program 1203, comprising computer readable code units executable by the processing circuit 1204, whereby the encoder 110 is operative to perform the methods of FIG. 3 and/or FIG. 11a and/or 11b.

In some other embodiments, the computer readable code units may cause the encoder 110 to perform the method according to FIG. 3 and/or 11a/b when the computer readable code units are executed by the encoder 110.

FIG. 12 further illustrates a carrier 1205, comprising the computer program 1203 as described directly above. The carrier 1205 may be one of an electronic signal, an optical signal, a radio signal, and a computer readable medium.

In some embodiments, the processing module 1201 comprises an Input/Output (I/O) unit 1206, which may be exemplified by a receiving module and/or a sending module as described below when applicable.

In further embodiments, the encoder 110 and/or the processing module 1201 may comprise one or more of an assigning module 1210, an encoding module 1230, an applying 1240, and a sending module 1250 as exemplifying hardware modules. In other examples, the aforementioned exemplifying hardware module may be implemented as one or more software modules. These modules are configured to perform a respective action as illustrated in e.g. FIG. 11a/b.

Therefore, according to the various embodiments described above, the encoder 110 is, e.g. by means of the processing module 1201 and/or any of the above mentioned modules, operative to, e.g. is configured to, perform the method of FIG. 11a/b.

The encoder 110, the processing module 1201 and/or the encoding module 1230 is configured to, for a first set of frames, encode the first set of frames into a first set of encoded units, while specifying at least one residual parameter in one or more of the first set of encoded units, wherein the at least one residual parameter instructs the decoder 120 of how to generate residuals; and to, for a second set of frames, encode the second set of frame into a second set of encoded units, while refraining from specifying the at least one residual parameter.

The encoder 110 and/or the processing module 1201 may be configured to refrain from specifying the at least one residual parameters only when processing inter-coded blocks of the second set of frames.

The encoded representation may be encoded using a color format including two or more color components. The encoder 110 and/or the processing module 1201 may be configured to refrain from specifying the at least one residual parameter only for a subset of the color components.

The encoder 110 and/or the processing module 1201 may be configured to perform the refraining from specifying the at least one residual parameter by replacing it with applying 205 a first weight value for rate distortion optimization “RDO” of the encoder 110 that may be higher than a second weight value for RDO of the encoder 110, wherein the first weight value may relate to the at least one residual parameter and the second weight value relates to motion vectors, whereby the at least one residual parameter may be encoded into the encoded units less frequent than frequency of encoding motion vectors into the encode units.

The encoder 110, the processing module 1201 and/or the sending module 1250 may be configured to send, to a target device 121, an indication of that the at least one residual parameter may be excluded from the second coded units. The encoded representation may comprise the indication.

The encoder 110, the processing module 1201 the assigning module 1210 may be configured to assign some of the frames to the first set of frames and all other of the frames to the second set of frames, wherein the first set may comprise every n:th frame of the frames, wherein n may be an integer. The n may be equal to two.

With reference to FIG. 12 again, a schematic block diagram of the encoder 110 is shown. Thus, the encoder 110 is configured to encode frames of a video sequence into an encoded representation of the video sequence, wherein the encoded representation comprises one or more encoded units representing the frames.

As mentioned, the frames may be associated to a specific frame rate that may be greater than 60 frames per second.

The encoder 110 may comprise a processing module 1201, such as a means, one or more hardware modules and/or one or more software modules for performing the methods described herein.

The encoder 110 may further comprise a memory 1202. The memory may comprise, such as contain or store, a computer program 1203.

According to some embodiments herein, the processing module 1201 comprises, e.g. ‘is embodied in the form of’ or ‘realized by’, a processing circuit 1204 as an exemplifying hardware module. In these embodiments, the memory 1202 may comprise the computer program 1203, comprising computer readable code units executable by the processing circuit 1204, whereby the encoder 110 is operative to perform the methods of FIG. 2 and/or FIG. 13.

In some other embodiments, the computer readable code units may cause the encoder 110 to perform the method according to FIG. 2 and/or 13 when the computer readable code units are executed by the encoder 110.

FIG. 12 further illustrates a carrier 1205, comprising the computer program 1203 as described directly above. The carrier 1205 may be one of an electronic signal, an optical signal, a radio signal, and a computer readable medium.

In some embodiments, the processing module 1201 comprises an Input/Output (I/O) unit 1206, which may be exemplified by a receiving module and/or a sending module as described below when applicable.

In further embodiments, the encoder 110 and/or the processing module 1201 may comprise one or more of an assigning module 1210, a dedicated processing module 1220, an encoding module 1230, an applying module 1240 and a sending module 1250 as exemplifying hardware modules. In other examples, the aforementioned exemplifying hardware module may be implemented as one or more software modules. These modules are configured to perform a respective action as illustrated in e.g. FIG. 13.

Therefore, according to the various embodiments described above, the encoder 110 is, e.g. by means of the processing module 1201 and/or any of the above mentioned modules, operative to, e.g. is configured to, perform the method of FIG. 13. Accordingly,

The encoder 110, the processing module 1201 and/or the encoding module is configured to, for a first set of frames, encode the first set of frames into a first set of encoded units, wherein each frame of the first set has a first level of fidelity, and to, for a second set of frames, encode the second set of frame into a second set of encoded units, wherein each frame of the second set has a second level of fidelity, wherein the second level of fidelity is less than the first level of fidelity.

The encoder 110, the processing module 1201 and/or the dedicated processing module may be configured to process the frames into the first set of frames or the second set of frames, before encoding of frames.

The encoded representation may be encoded using a color format including two or more color components, wherein the first level of fidelity may be obtained by that the encoder 110, the processing module 1201 and/or the dedicated processing module may be configured to perform processing while specifying information for all color components of the color format for the first set of frames, wherein the second level of fidelity may be obtained by that the encoder 110, the processing module 1201 and/or the dedicated processing module may be configured to perform processing while refraining from specifying information for at least one of the color components of the color format for the second set of frames. The color components of the color format consist of two chroma components, and wherein the color format may comprise a luma component.

The encoder 110, the processing module 1201 and/or the encoding module may be configured to encode a flag into the encoded representation, wherein the flag indicates whether said at least one block may be encoded with the first level of fidelity.

The first level of fidelity may be obtained by that the encoder 110, the processing module 1201 and/or the dedicated processing module may be configured to perform processing while utilizing a first frame resolution for the first set of frames, wherein the second level of fidelity may be obtained by that the encoder 110, the processing module 1201 and/or the dedicated processing module may be configured to perform processing while utilizing a second frame resolution for the second set of frames, wherein the second frame resolution may be less than the first frame resolution.

The first level of fidelity may be obtained by that the encoder 110, the processing module 1201 and/or the dedicated processing module may be configured to perform processing while utilizing a first bit depth of color information for the first set of frames, wherein the second level of fidelity may be obtained by that the encoder 110, the processing module 1201 and/or the dedicated processing module may be configured to perform processing while utilizing a second bit depth of color information for the second set of frames, wherein the second bit depth of color information may be less than the first bit depth of color information.

The first level of fidelity may be obtained by that the encoder 110, the processing module 1201 and/or the dedicated processing module may be configured to perform processing while utilizing a first color format for the first set of frames, wherein the second level of fidelity may be obtained by that the encoder 110, the processing module 1201 and/or the dedicated processing module may be configured to perform processing while utilizing a second color format for the second set of frames, wherein a number of bits used for the second color format may be less than a number of bits used for the first color format.

The encoder 110, the processing module 1201 and/or the assigning module may be configured to assign some of the frames to the first set of frames and all other of the frames to the second set of frames, wherein the first set may comprise every n:th frame of the frames, wherein n may be an integer. The n may be equal to two.

In FIG. 13, an exemplifying, schematic flowchart of the method in the decoder 120 according to the embodiments of the decoder is shown. The same reference numerals as used in connection with FIG. 2 have been applied to denote the same or similar actions. The decoder 120 performs a method for decoding an encoded representation of frames of a video sequence into frames of the video sequence.

As mentioned, the encoded representation comprises one or more encoded units representing the frames of the video sequence. The frames may be associated to a specific frame rate that may be greater than 60 frames per second.

One or more of the following actions may be performed in any suitable order.

### Action 209

The decoder 120 may receive the encode representation from the encoder 110 and/or the source device 111.

### Action 210

The second set of frames may comprise at least one block. The decoder 120 may decode a flag from the encoded representation, wherein the flag indicates whether said at least one block may be encoded with the first level of fidelity or not.

### Action 211

The decoder 120 may receive the indication from the encoder 110. The indication is described above in connection with action 208.

### Action 212

The decoder 120 decodes a first set of encoded units into a first set of frames, while obtaining a first level of fidelity for each frame of the first set.

### Action 213

The decoder 120 decodes a second set of encoded units into a second set of frames, while obtaining a second level of fidelity of each frame of the second set.

### Action 214

The second set of frames may comprise at least one block. The decoder 120 may extract information from said at least one block, said extracted information being one of motion information, color information or at least one residual parameter.

### Action 215

The decoder 120 may determine based on the extracted information whether said at least one block may be encoded with the first level of fidelity or not.

### Action 216

When the second level of fidelity is less than the first level of fidelity, the decoder 120 enhances the second set of frames towards obtaining the first level of fidelity for each frame of the second set.

The encoded representation may be encoded using a color format including two or more color components, wherein the first and second levels of fidelity relates to availability of at least one color component, wherein the enhancing 214 comprises deriving at least one further color component for each frame of the second set based on said at least one color component that may be available from frames preceding and following said each frame.

The derived at least one further color component represents chroma information of the color format, wherein the color format may be a YUV format.

The first and second levels may relate to frame resolution, wherein the enhancing 216 may comprise up-scaling the second level of frame resolution to the first level of frame resolution.

The first and second levels may relate to bit depth of color information, wherein the enhancing 216 may comprise up-sampling the second level of bit depth to the first level of bit depth.

The first level may relate to a first color format and the second level may relate to a second color format, wherein the enhancing 216 may comprise converting the second color format to the first color format.

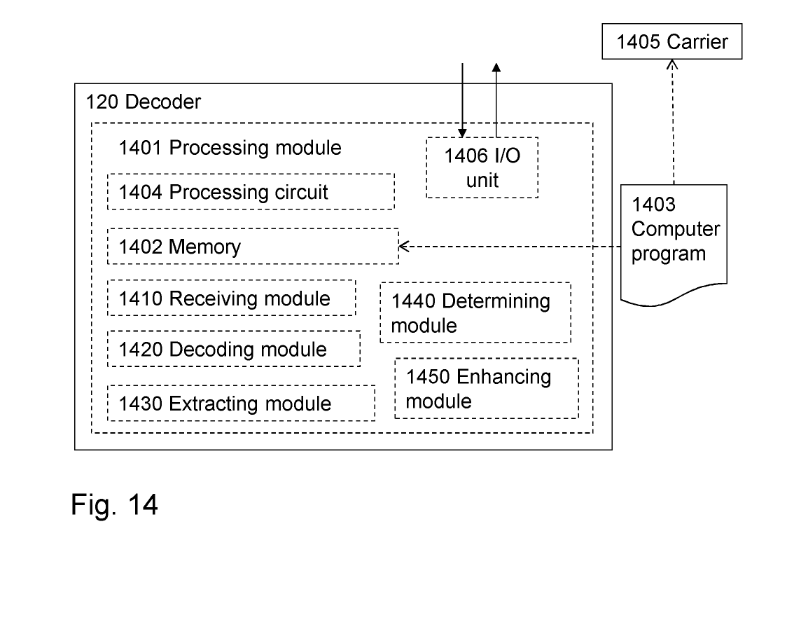

With reference to FIG. 14, a schematic block diagram of the decoder 120 is shown. Thus, the decoder 120 is configured to decode an encoded representation of frames of a video sequence into frames of the video sequence, wherein the encoded representation comprises one or more encoded units representing the frames of the video sequence.

As mentioned, the frames may be associated to a specific frame rate that may be greater than 60 frames per second.

The decoder 120 may comprise a processing module 1401, such as a means, one or more hardware modules and/or one or more software modules for performing the methods described herein.

The decoder 120 may further comprise a memory 1402. The memory may comprise, such as contain or store, a computer program 1403.

According to some embodiments herein, the processing module 1401 comprises, e.g. ‘is embodied in the form of’ or ‘realized by’, a processing circuit 1404 as an exemplifying hardware module. In these embodiments, the memory 1402 may comprise the computer program 1403, comprising computer readable code units executable by the processing circuit 1404, whereby the decoder 120 is operative to perform the methods of FIG. 2 and/or FIG. 13.

In some other embodiments, the computer readable code units may cause the decoder 120 to perform the method according to FIG. 2 and/or 13 when the computer readable code units are executed by the decoder 120.

FIG. 14 further illustrates a carrier 1405, comprising the computer program 1403 as described directly above. The carrier 1405 may be one of an electronic signal, an optical signal, a radio signal, and a computer readable medium.

In some embodiments, the processing module 1401 comprises an Input/Output (I/O) unit 1406, which may be exemplified by a receiving module and/or a sending module as described below when applicable.

In further embodiments, the decoder 120 and/or the processing module 1401 may comprise one or more of a receiving module 1410, a decoding module 1420, a extracting module 1430, a determining module 1440 and a enhancing module 1450 as exemplifying hardware modules. In other examples, the aforementioned exemplifying hardware module may be implemented as one or more software modules. These modules are configured to perform a respective action as illustrated in e.g. FIG. 13.

Therefore, according to the various embodiments described above, the decoder 120 is, e.g. by means of the processing module 1401 and/or any of the above mentioned modules, operative to, e.g. is configured to, perform the method of FIG. 13.

Accordingly, the decoder 120, the processing module 1401 and/or the decoding module, is configured to decode a first set of encoded units into a first set of frames, while obtaining a first level of fidelity for each frame of the first set.

The decoder 120, the processing module 1401 and/or the decoding module 1420 is configured to decode a second set of encoded units into a second set of frames, while obtaining a second level of fidelity of each frame of the second set.

The decoder 120, the processing module 1401 and/or the enhancing module 1450 is configured to, when the second level of fidelity is less than the first level of fidelity, enhance the second set of frames towards obtaining the first level of fidelity for each frame of the second set.

The encoded representation may be encoded using a color format including two or more color components, wherein the first and second levels of fidelity relates to availability of at least one color component, wherein the decoder 120, the processing module 1401 and/or the enhancing module may be configured to enhance by deriving at least one further color component for each frame of the second set based on said at least one color component that may be available from frames preceding and following said each frame.

The derived at least one further color component represents chroma information of the color format, wherein the color format may be a YUV format.

The second set of frames may comprise at least one block, wherein the decoder 120, the processing module 1401 and/or the decoding module may be configured to decode a flag from the encoded representation, wherein the flag indicates whether said at least one block may be encoded with the first level of fidelity or not.

The second set of frames may comprise at least one block. The decoder 120, the processing module 1401 and/or the extracting module may be configured to extract information from said at least one block, said extracted information being one of motion information, color information or at least one residual parameter.

The decoder 120, the processing module 1401 and/or the determining module may be configured to determine based on the extracted information whether said at least one block may be encoded with the first level of fidelity or not.

The first and second levels may relate to frame resolution. The decoder 120, the processing module 1401 and/or the enhancing module may be configured to enhance by up-scaling the second level of frame resolution to the first level of frame resolution.

The first and second levels may relate to bit depth of color information. The decoder 120, the processing module 1401 and/or the enhancing module may be configured to enhance by up-sampling the second level of bit depth to the first level of bit depth.

The first level may relate to a first color format and the second level may relate to a second color format. The decoder 120, the processing module 1401 and/or the enhancing module may be configured to enhance by converting the second color format to the first color format.

As used herein, the term “processing module” may in some examples refer to a processing circuit, a processing unit, a processor, an Application Specific integrated Circuit (ASIC), a Field-Programmable Gate Array (FPGA) or the like. As an example, a processor, an ASIC, an FPGA or the like may comprise one or more processor kernels. In these examples, the processing module is thus embodied by a hardware module. In other examples, the processing module may be embodied by a software module. Any such module, be it a hardware, software or combined hardware-software module, may be a determining means, estimating means, capturing means, associating means, comparing means, identification means, selecting means, receiving means, sending means or the like as disclosed herein. As an example, the expression “means” may be a module or a unit, such as a determining module and the like correspondingly to the above listed means.

As used herein, the expression “configured to” may mean that a processing circuit is configured to, or adapted to, by means of software configuration and/or hardware configuration, perform one or more of the actions described herein.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a Multimedia Card (MMC), etc.

As used herein, the term “computer readable code units” may be text of a computer program, parts of or an entire binary file representing a computer program in a compiled format or anything there between.

As used herein, the terms “number”, “value” may be any kind of digit, such as binary, real, imaginary or rational number or the like. Moreover, “number”, “value” may be one or more characters, such as a letter or a string of letters. “Number”, “value” may also be represented by a bit string.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1-64. (canceled)

65. A method, performed by an encoder, for encoding frames of a video sequence into an encoded representation of the video sequence, wherein the encoded representation comprises one or more encoded units representing the frames, wherein the encoded representation is encoded using a color format including two or more color components, the method comprising:
for a first set of frames, encoding the first set of frames into a first set of encoded units, while specifying at least one residual parameter in one or more of the first set of encoded units, wherein the at least one residual parameter instructs the decoder of how to generate residuals; and
for a second set of frames, encoding the second set of frames into a second set of encoded units, while refraining from specifying the at least one residual parameter, wherein the refraining from specifying the at least one residual parameter is performed only for inter-coded blocks of the second set of frames and only for a subset of the color components.

66. The method of claim 65, wherein the refraining from specifying the at least one residual parameter is replaced by applying a first weight value for rate distortion optimization “RDO” of the encoder that is higher than a second weight value for RDO of the encoder, wherein the first weight value relates to the at least one residual parameter and the second weight value relates to motion vectors, whereby the at least one residual parameter are encoded into the encoded units less frequent than frequency of encoding motion vectors into the encode units.

67. The method of claim 65, wherein the method further comprises:
sending, to a target device, an indication of that the at least one residual parameter is excluded from the second coded units.

68. The method of claim 65, wherein the method further comprises assigning some of the frames to the first set of frames and all other of the frames to the second set of frames, wherein the first set comprises every n:th frame of the frames, wherein n is an integer.

69. A method, performed by an encoder, for encoding frames of a video sequence into an encoded representation of the video sequence, wherein the encoded representation comprises one or more encoded units representing the frames, wherein the method comprises:
for a first set of frames, encoding the first set of frames into a first set of encoded units, wherein each frame of the first set has a first level of fidelity;
for a second set of frames, encoding the second set of frame into a second set of encoded units, wherein each frame of the second set has a second level of fidelity, wherein the second level of fidelity is less than the first level of fidelity.

70. The method of claim 69, wherein the method comprises:
before encoding of frames, processing the frames into the first set of frames or the second set of frames.

71. The method of claim 70, wherein the encoded representation is encoded using a color format including two or more color components, wherein the first level of fidelity is obtained by that the processing is performed while specifying information for all color components of the color format for the first set of frames, wherein the second level of fidelity is obtained by that the processing is performed while refraining from specifying information for at least one of the color components of the color format for the second set of frames.

72. The method of claim 69, wherein
at least one block of at least one frame of the second set is encoded with the first level of fidelity, and
the method further comprises encoding a flag into the encoded representation, wherein the flag indicates whether said at least one block is encoded with the first level of fidelity.

73. A method, performed by a decoder, for decoding an encoded representation of frames of a video sequence into frames of the video sequence, wherein the encoded representation comprises one or more encoded units representing the frames of the video sequence, wherein the encoded representation is encoded using a color format including two or more color components, wherein the method comprises:
decoding a first set of encoded units into a first set of frames, while obtaining a first level of fidelity for each frame of the first set, wherein the first level of fidelity relates to availability of at least one color component;
decoding a second set of encoded units into a second set of frames, while obtaining a second level of fidelity of each frame of the second set, wherein the second level of fidelity relates to availability of at least one color component,
when the second level of fidelity is less than the first level of fidelity, enhancing the second set of frames towards obtaining the first level of fidelity for each frame of the second set, wherein the enhancing comprises deriving at least one further color component for each frame of the second set based on said at least one color component that is available from frames preceding and following said each frame.

74. The method of claim 73, wherein the second set of frames comprises at least one block, wherein the method comprises:
decoding a flag from the encoded representation, wherein the flag indicates whether said at least one block is encoded with the first level of fidelity or not.

75. The method of claim 73, wherein the second set of frames comprises at least one block, wherein the method comprises:
extracting information from said at least one block, said extracted information being one of motion information, color information or at least one residual parameter;
determining based on the extracted information whether said at least one block is encoded with the first level of fidelity or not.

76. The method of claim 73, wherein the derived at least one further color component represents chroma information of the color format, wherein the color format is a YUV format.

77. An encoder configured to encode frames of a video sequence into an encoded representation of the video sequence, wherein the encoded representation comprises one or more encoded units representing the frames, wherein the encoded representation is encoded using a color format including two or more color components, wherein the encoder comprises:
a memory; and
a processing circuit coupled to the memory, wherein the processing circuit is configured to:
for a first set of frames, encode the first set of frames into a first set of encoded units, while specifying at least one residual parameter in one or more of the first set of encoded units, wherein the at least one residual parameter instructs the decoder of how to generate residuals; and
for a second set of frames, encode the second set of frames into a second set of encoded units, while refraining from specifying the at least one residual parameter, wherein the refraining from specifying the at least one residual parameter is performed only for inter-coded blocks of the second set of frames and only for a subset of the color components.

78. The encoder of claim 77, wherein the encoder is configured to perform the refraining from specifying the at least one residual parameter by replacing it with applying a first weight value for rate distortion optimization “RDO” of the encoder that is higher than a second weight value for RDO of the encoder, wherein the first weight value relates to the at least one residual parameter and the second weight value relates to motion vectors, whereby the at least one residual parameter are encoded into the encoded units less frequent than frequency of encoding motion vectors into the encode units.

79. A decoder configured to decode an encoded representation of frames of a video sequence into frames of the video sequence, wherein the encoded representation comprises one or more encoded units representing the frames of the video sequence, wherein the decoder comprises:
a memory; and
a processing circuit coupled to the memory, wherein the processing circuit is configured to:
decode a first set of encoded units into a first set of frames, while obtaining a first level of fidelity for each frame of the first set; and
decode a second set of encoded units into a second set of frames, while obtaining a second level of fidelity of each frame of the second set,
when the second level of fidelity is less than the first level of fidelity, enhance the second set of frames towards obtaining the first level of fidelity for each frame of the second set.

80. The decoder of claim 79, wherein the encoded representation is encoded using a color format including two or more color components, wherein the first and second levels of fidelity relates to availability of at least one color component, wherein the decoder is configured to enhance by deriving at least one further color component for each frame of the second set based on said at least one color component that is available from frames preceding and following said each frame.

81. The decoder of claim 79, wherein the first level relates to a first color format and the second level relates to a second color format, wherein the decoder is configured to enhance by converting the second color format to the first color format.

82. A computer program product comprising a non-transitory computer readable medium storing a computer program comprising computer readable code units which when executed on an encoder causes the encoder to perform the method of claim 65.

83. A computer program product comprising a non-transitory computer readable medium storing a computer program comprising computer readable code units which when executed on an encoder causes the encoder to perform the method of claim 69.

84. A computer program product comprising a non-transitory computer readable medium storing a computer program comprising computer readable code units which when executed on a decoder causes the decoder to perform the method of claim 73.
